(19) United States
(12) Patent Application Publication
(10) Pub. No.: US 2008/0219306 A1
(43) Pub. Date: Sep. 11, 2008

(54) Laser Power Algorithm for Low Power Applications

(75) Inventors: Ivon Franciscus Helwegen, St. Odilienberg (NL); Henricus Renatus Martinus Verberne, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,193

(22) PCT Filed: Jun. 27, 2006
(86) PCT No.: PCT/IB06/52134

§ 371 Date: Dec. 28, 2007

Related U.S. Application Data
(60) Provisional application No. 60/695,656, filed on Jun. 30, 2005.

(51) Int. Cl. H01S 3/10

(52) U.S. Cl. 372/38.02

(57) ABSTRACT

A system and method to minimize the power consumed by a light source. The power of a light source in controlled in response to a determination of the quality of the received data in order to optimize a reduction in power consumption. If the quality of the received data is sufficient, then the laser power can be reduced in order to save power.

The present invention pertains to low power laser applications and, more particularly, to conserving power in power laser applications using the laser driving circuits and mechanisms for reducing power consumption

Power consumption within portable storage systems has been and remains a major issue for these systems. The period of time that any portable device is able to run on battery power is one of the major specifications of the portable device. There are currently available numerous products that employ optical storage devices, such as CD or based DVD-systems. Additionally, future systems are currently planned for release such as portable blu-ray disc (BD). Another currently planned system is T-ROM which is an optical data card read-out system having no rotating disc wherein read-out is accomplished using an array of spots illuminating bit-marks in parallel. The illuminated bit-marks are captured with an image sensor and processed electronically. Additionally, holographic storage systems are planned that use optical readout systems. Techniques that conserve power consumption on these types of systems are significantly desirable features and good marketing tools for these storage products.

Speed, processing capabilities and the overall features of portable systems has continued to increase resulting in portable systems that require more and more power. Advances in power management have reduced to power demands of these portable systems; however, power consumption continues to be a problem that exists within the art of portable storage devices.

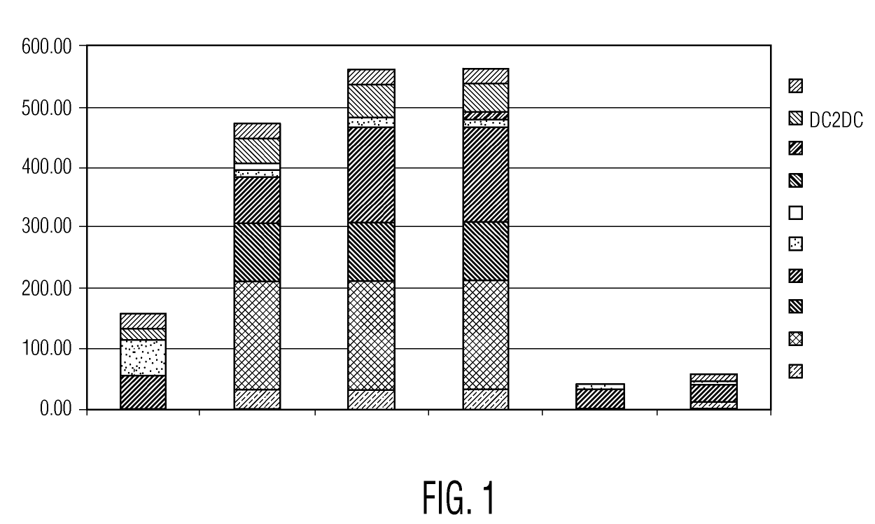

FIG. 1 illustrates the power consumption performed by various areas for different actions with a specific type of optical storage device. As seen in FIG. 1, the laser and the laser driver consume a good deal of total power used by these systems. Therefore, reductions in laser power can result in significant overall reductions in power consumption used by the entire system.

A number of prior art techniques have employed algorithms to modify the laser power used in reading data out of a medium; however, these algorithms are not based on power consumption. Typically, these algorithms are based on constant light power (forward sense) and best quality data readout. Since the prior art algorithms do not specifically target power concerns, their power savings are less then optimum.

U.S. Patent Publication US20030137912 is an example of a prior art reference that addresses power conservation. U.S. Patent Publication US20030137912 preserves power by signal processing techniques that reduce clock and sampling speeds. However, the most power demanding component in the system is the laser and, especially in portable applications, the laser provides that greats power drain. Therefore, there remains a need within the art for a system and method that addresses laser driving for reducing power consumption.

In view of the foregoing discussion, there remains a need in the art for techniques that reduce power consumption in portable devices.

It is an object of the invention to reduce that power consumption in optical systems that make use of a laser (or a different light source) for data readout.

It is further ran object of the invention to reduce power requirements in portable applications of optical systems.

The foregoing objects are realized by controlling laser power in response to a determination of the quality of the received data in order to optimize a reduction in power consumption. If the quality of the received data is sufficient, then the laser power can be further reduced in order to save power.

FIG. 1 is a series of bar charts illustrating power consumption calculation within optical drives;

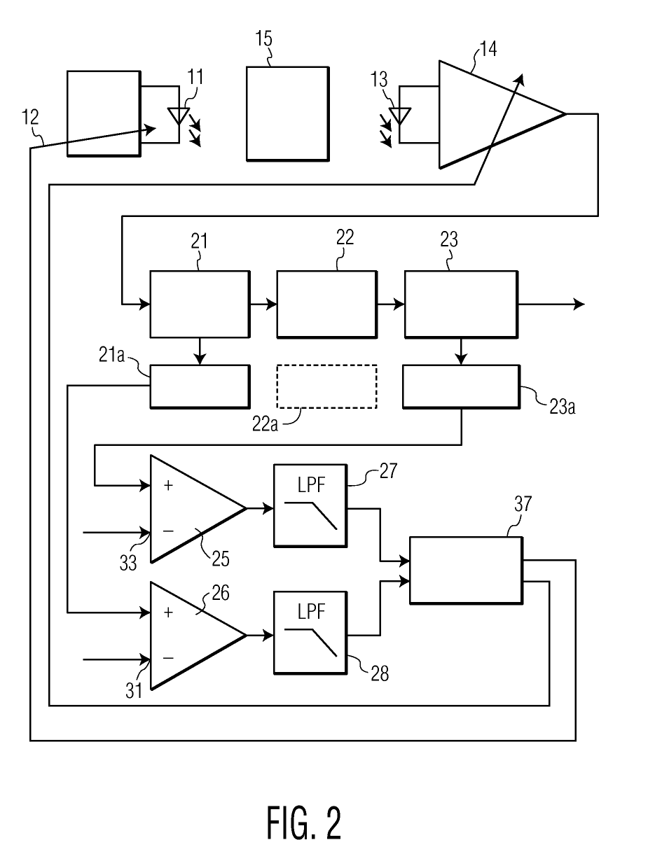

FIG. 2 is a block diagram of the laser power control setup;

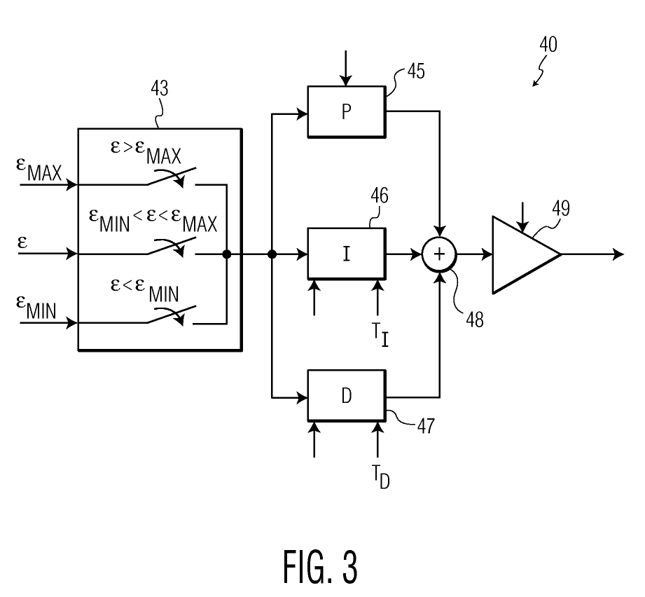

FIG. 3 is a diagram of a controller implementation;

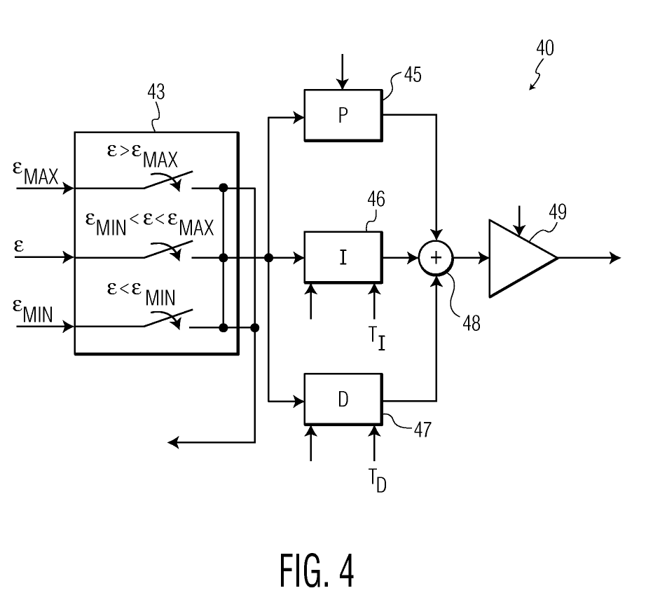

FIG. 4 is a diagram of a modified controller implementation; and

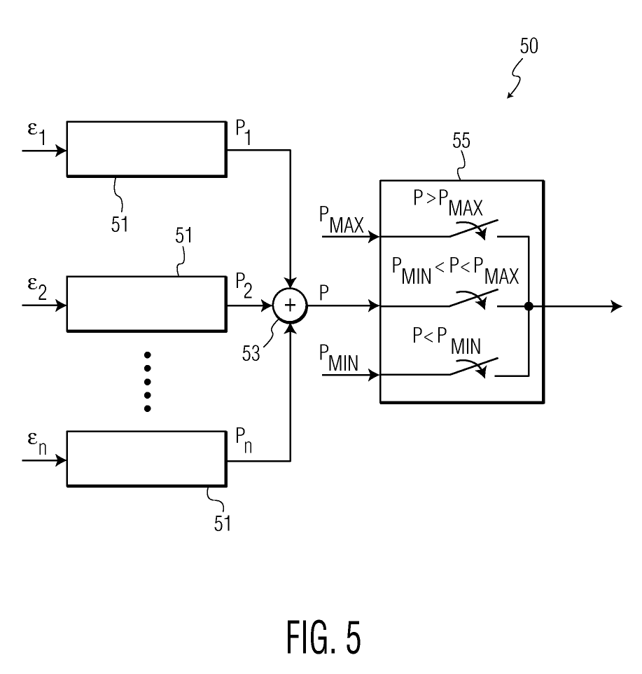

FIG. 5 is a diagram of an overall controller implementation

FIG. 2 is a block diagram illustrating an embodiment of a laser power control system, generally referred to as 20. It should be understood that while FIG. 2 is illustrative of an embodiment of the invention, other embodiments for laser control will be readily apparent to those skilled in the art. Therefore, the embodiment shown in FIG. 2 is illustrative of only a single embodiment that employs the concepts of the invention and it will be readily apparent to those skilled in the art that these concepts can be employed within numerous different optical system embodiments.

Still referring to FIG. 2, laser 11 is driven by a laser driver 12 to generate the necessary light in order to perform optical readout of data on an optical media (not show). The laser driver 12 shown in FIG. 2 is capable of modifying the output power of laser 11. It is envisioned that the laser driver 12 can perform light power modulation. As envisioned by the embodiment shown in FIG. 2, light passes through an optical system 15, to either read or write data to or from an optical media (not shown) and reflects back to hit the detector 13. The detector 13 generates a signal that is amplified by amplifier 14. The amplified signal will then undergo processing as described below.

PLL/bit-detection 21 processes the amplified signal from detector 13 to perform bit detection and recover the clock rate that is currently being used to recover data. The PLL/bit-detection 21 determines a measure of quality 21a for the detected bits. There are various schemes, depending on the implementation, such as threshold detection, viterbi or numerous other schemes, that can provide an indication of quality 21 from processing jitter, modulation, asymmetry, detected erasures, signal-to noise ratio (SNR), or other features obtained from the reflected light. Channel decoder 22 performs processing at the recovered clock rate determined by PLL/bit-detection 21 to decode the bits within the data stream by inverse channel coding to retrieve the user bits. The channel decoder 22 could also have a quality indicator 22a to provide an indication of such parameters as a run length push back, false run lengths, etc. Quality indicator 22a is shown with a dotted outline in order to reduce complexity of the block schematic of FIG. 2. Error correction 23 processes data that has been decoded by the channel decoder 22 to perform error correction. From error correction 23, an error rate 23a quality indicator is obtained, referred to as the error rate (bit error rate, symbol error rate, etc.). The foregoing processing describes various quality and error indicators. It will be understood by those skilled in the art that these and other indicators can be used separately or in combination to determine the effectiveness of the current laser power being used.

The quality indicators 21a, 23a and 22a can be referenced to a nominal value. In the embodiment illustrated in FIG. 2 this nominal value is subtracted from its' respective indicator, however, it will be readily apparent to those skilled in the relevant arts that numerous methodologies can be used to acquire a relative comparison of the indicators to a nominal value. The nominal values are bias levels that are indicative of the nominal quality indicator values. The exact value for the bias levels depends on the system (light path, mechanics, electronics, error correction etc.), so the values need to be determined in accordance with the margins of each engine. For example, most BD systems have jitter values of about 12% as the system limit and jitter values of about 9-10% give nominal performance.

The nominal values in another embodiment are bias values for each particular quality indicator. Therefore, each of quality indicators 21a, 22a, and 23a can have separate bias values. The embodiment as illustrated in FIG. 2 places Bias 1 on the negative input 33 of subtraction device 25 to be subtracted from the error rate 23a quality indicator. The output value of subtraction device 25 is referred to herein as the quality indicator error value for the error rate determined from quality indicator for error rate 23a. Also as shown in FIG. 2, Bias 2 is placed on the negative input 31 of subtraction device 26 and subtracted from the determination made by quality indicator 21a. The output value of subtraction device 26 is called the quality indicator error value for the quality determined from quality indicator 21a.

The quality indicators 21a, 22a 23a are high frequency signals due to the fact that they are extracted from high bit-rate signals. It is not desirable to allow laser 11 to react to high frequency signals because high frequency signal changes can introduce noise, oscillations or increase of power consumption of the laser 11. Therefore, power adjustment applied to laser 11 needs to be accomplished at a very low frequency in order to prevent the laser 11 from reacting to a high frequency signal. Therefore, low pass filters 27, 28 are applied to the quality indicator error values to reduce the bandwidth of the quality indicator error values to only a few hertz.

Control system 29 adapts the laser power on the basis of the quality indicator error values. The control system 29 can be implemented, for example, using a very slow Proportional (P) or Proportional Integral-acting (PI) type of controller. The functionality of control system 29 could also be performed by the servo digital signal processor (DSP) because it does not require a great deal of processing power. The first output 35 of control system 29 drives the laser driver such that the laser power is adapted in accordance with the output of the control system. The second output 37 of control system 29 drives the detector amplifier 14 to assure that the signal level of the bit detection-input remains the same. Second input 37 is a normalizing function. The detector amplifier 14 drive is inversely proportional to drive of the laser power. The output of the photo detector amplifier 14 should stay at the same level. The output power is normally fed to an ADC (not shown) and it is desirable to use the complete range of this ADC.

Inside the control system 29, functionality is provided to check if the quality indicator stays within the margins of the system. The margins are very system dependant (like the nominal values previously discussed). The margins can be calculated from the maximum read laser power levels on a disc, before a disc starts to erase data. For example, if the error rate gets too high, the system might decide to reset itself and start again from normal laser power or stay at a maximum level. Otherwise, when the laser power gets too high (e.g. on bad discs) the laser power may reach the erase level and start to erase the media.

Before the error signals can enter the control system 29, they need to be low pass filtered, so that other effects do not influence the system, like bit- or servo effects, scratches or fingerprints etc.

The control system itself is in fact a normal PI or Proportional-Integral Differential (PID) control system together with some none linear control to stay within the margins of the error signal. Because of the quite low frequencies the control system has to operate at, probably a PI controller will do.

FIG. 3 shows an embodiment with an implementation of control system 40 using one single error signal. FIG. 3 illustrates a control system 40 that employs a single PID controller having settings for gains (GAIN_{P}, GAIN_{I} and GAIN_{D}) and cut off frequencies (T_{I} and T_{D}) that can be adjusted. At the left side of FIG. 3, error check block 43 determines the error signals are in between their minimum and maximum values. If the error is less than the minimum then the minimum value is output by the error check block 43. If the error exceeds the maximum value, the error check block outputs the maximum value.

FIG. 4 illustrates a slightly different implementation of FIG. 3. In FIG. 4, if the error signal is less than the minimum or exceeds the maximum value, a reset pulse is sent to the controller.

A combination of the 2 implementations shown in FIG. 3 and FIG. 4 is also possible. For example, if the error signal stays at the minimum or maximum value for a certain period (e.g. 5 sec.), then there is a problem with the system and the system sends a reset pulse.

FIG. 5 is an illustration of the overall system implementation. The PID controllers 51 provide outputs for all the error values (which are the quality indicators) are added by summation device 53. Laser power block 55 uses the value from summation device 53 to determine the laser power. Laser power block 55 employs a minimum and maximum setting for the output power for the laser. If the value from summation device 53 is less than the minimum laser power then laser power block 55 outputs the minimum laser power. If the value from summation device 53 is greater than the maximum laser power then laser power block 55 outputs the maximum laser power. If the value from summation device 53 is between the minimum and the maximum laser power then laser power block 55 outputs the laser power as indicated by the summation device 53.

It should be noted that the weighting factors for all the PID-controllers 51 does not need to be the same. The gain factors can be adjusted by the Gain setting of each PID-controller.

The foregoing describes simple techniques whereby laser power can be reduced to a minimum level needed for good data readout, thereby, conserving power. Embodiments of the foregoing can be implemented wherein the laser power is constantly controlled during readout. Other embodiments can control laser power that is required for good readout by calibrating laser power at one or more places on the media during startup. The power values for the laser can be stored and the laser power adapted from the stored values in a lookup table during readout.

While the foregoing description details embodiments of the invention, numerous modifications to the foregoing described embodiments will be readily apparent to those skilled in the art. Accordingly, the scope of the invention should not be restricted to the foregoing described embodiment and should be measured by the appended claims.

1. A method for controlling power within a light source comprising:
driving a light source at a predetermined power level;
focusing light from the light source onto a target;
detecting light reflected from the target;
determining at least one quality measure for detected reflected light;
low pass filtering of the quality measure;
generating a new power level for the light source in response to the at least one quality measure; and
adjusting the predetermined power of the light source to the new power level.

2. The method of claim 1, wherein determining further comprises referencing the at least one quality measure to at least one predetermined threshold value to form at least one quality indicator error value.

3. The method of claim 2, wherein generating further comprises generating the new power level in response to the at least one quality indicator error value.

4. The method of claim 3, wherein the new power level is a reduced power level.

5. The method of claim 3, wherein referencing further comprises removing the threshold value from the quality measure to create the quality indicator value.

6. The method of claim 5, wherein removing further comprises subtracting the threshold value from the quality measure.

7. The method of claim 4, wherein generating further comprises generating the reduced power level for the light source in response to a plurality of quality indicator error values.

8. The method of claim 6 wherein generating further comprises generating a portion of the power level for each of the plurality of error values.

9. The method of claim 8 wherein generating further comprises summing the portions of the power level for each of the plurality of error values

10. The method of claim 9 wherein adjusting further comprises maintaining the power levels within a predetermined set of margins.

11. An optical system with power control for a light source comprising:
a driver configured to drive the light source at a predetermined power level;
a set of optics for focusing a beam of light from the light source onto a target;
a detector that detects light reflected from the target;
a determining mechanism that determines at least one quality measure for detected reflected light;
a low pass filter configured to receive the quality measure;
a power generation device coupled to the low pass filter for creating a new power level for the light source in response to the at least one quality measure; and
a power adjustment device coupled to the power generation device for adjusting the predetermined power of the light source to the new power level.

12. The system of claim 11, wherein the determining mechanism further comprises a referencing device that references the at least one quality measure to at least one predetermined threshold value to form at least one quality indicator error value.

13. The system of claim 12, wherein the power generation device further creates the new power level in response to the at least one quality indicator error value.

14. The system of claim 13, wherein the new power level is a reduced power level.

15. The system of claim 13, wherein the referencing device further comprises a threshold removing device for removing the threshold value from the quality measure to create the quality indicator value.

16. The system of claim 15, wherein the threshold removing device further subtracts the threshold value from the quality measure.

17. The system of claim 14, wherein the power generation device further generates the reduced power level for the light source in response to a plurality of quality indicator error values.

18. The system of claim 16 wherein the power generation device further generates a portion of the power level for each of the plurality of error values.

19. The system of claim 18 wherein the power generation device further creates a summation of the portions of the power level for each of the plurality of error values.

20. The system of claim 19 wherein the power adjustment device further maintains the power levels within a predetermined set of margins.
